(19) United States
(12) Patent Application Publication
(10) Pub. No.: US 2014/0249901 A1
(43) Pub. Date: Sep. 4, 2014

(54) SYSTEM AND METHOD FOR CIRCLE OF FAMILY AND FRIENDS MARKETPLACE

(71) Applicants: Bahman Qawami, San Jose, CA (US); Hossein Abar, Diablo, CA (US); Don Kadish, San Jose, CA (US); Don McAllister, San Jose, CA (US)

(72) Inventors: Bahman Qawami, San Jose, CA (US); Hossein Abar, Diablo, CA (US); Don Kadish, San Jose, CA (US); Don McAllister, San Jose, CA (US)

(21) Appl. No.: 14/273,916

(22) Filed: May 9, 2014

Related U.S. Application Data
(63) Continuation-in-part of application No. 13/689,697, filed on Nov. 29, 2012.
(60) Provisional application No. 61/565,988, filed on Dec. 2, 2011.
(60) Provisional application No. 61/586,765, filed on Jan. 14, 2012.
(60) Provisional application No. 61/565,979, filed on Dec. 1, 2011.
(60) Provisional application No. 61/594,699, filed on Feb. 3, 2012.

(51) Int. Cl. G06Q 30/02

(52) U.S. Cl. CPC G06Q 30/0215
USPC 705/14.17

(57) ABSTRACT

A customer selects a payment source and authorizes payment by sending Short Message Service (SMS) text messages or secure hypertext transfer protocol (HTTPS) requests from the customer's mobile phone or device. A SMS payment software-plugin is installed on a Point-Of-Sale (POS) terminal and launches a price match search and can fetch customer rewards. When a customer requests to pay by SMS, the plugin is activated and the customer's mobile phone number and zip code or POS PIN are entered on the POS terminal. The POS terminal sends a request to a SMS payment system, which sends SMS text messages to the customer's mobile device. The details are discussed. The application on marketplace based on circle of friends and family is also discussed, which connects the people to schools or universities, to support them financially, through Koincloud marketplace.

### RELATED APPLICATIONS

This application is a CIP of another application Ser. No. 13/689,697, filed 29 Nov. 2012, with the same assignee, which in turn claims the benefit of the U.S. provisional applications for “Enabling user transaction to request, order, post transaction using mobile phone and/or online”, U.S. Provisional Ser. No. 61/565,988, filed Dec. 2, 2011, and “Shopping with Spenzi”, U.S. Provisional Ser. No. 61/586,765, filed Jan. 14, 2012, and “Enabling users to access process order post and login via a transactional based system”, U.S. Provisional Ser. No. 61/565,979, filed Dec. 1, 2011, and “Spenzi SaaS Payment Gateway Host For Mobile Payment”, U.S. Provisional Ser. No. 61/594,699, filed Feb. 3, 2012. This application is also related to the co-pending application for “Enabling a Merchant's Storefront POS (Point of Sale) System to Accept a Payment Transaction Verified by SMS Messaging with Buyer's Mobile Phone”, U.S. Ser. No. 13/466,435, filed May 8, 2012 and “Gifting and Sharing Using SMS Messages for Shared Coupon/Gift-Card Auto-Redemption and Multi-Source Payment from Buyer's Mobile Phone”, U.S. Ser. No. 13/677,267, filed Nov. 14, 2012. It claims the benefit of the all of the above applications and priority dates. It also incorporates by reference all the teachings of the above applications.

### FIELD OF THE INVENTION

This invention relates to mobile payment systems, and more particularly to enable payment at a merchant Point-Of-Sale (POS) system using standard mobile phones to select and verify payment sources.

### BACKGROUND OF THE INVENTION

Mobile payments combine mobile phones with cashless payments such as by credit cards and debit cards. Mobile payments allow the user to pay for a purchase using a mobile device such as a smartphone. Many different mobile payment schemes have been proposed, and several are being tested.

A problem with some mobile payment schemes is that they require a fairly sophisticated smartphone, such as an Android phone using Google software, or an iPhone using Apple software. Some mobile payment systems may support one brand of smartphones but not other brands. Since the smartphone market is currently split, mobile payment systems that support only Apple iOS, Android, Windows Mobile, or Blackberry OS phones eliminate half or more of the potential cell-phone users.

While smartphones have received a great deal of attention, many users still have older cell phones that do not run Apple iOS, Android, Windows Mobile, or Blackberry OS software. The high cost of smartphones limits their acceptance in cost-sensitive foreign markets and among cost-sensitive customers.

The fragmented mobile phone market limits the success of mobile payment systems that function with only a particular kind of smartphone, or that do not work with older legacy cell phones. The inventors believe that the widespread acceptance of a mobile payment system depends on it being able to operate with all kinds of mobile phones, including smart phones of all types, and legacy cell phones.

What is desired is a mobile payment system that operates with all kinds of mobile phones, allowing the customer to select and verify the payment source using his mobile phone. A mobile payment system that enables a merchant's Point-Of-Sale (POS) system to accept a payment that is assisted by a user's mobile phone is desirable, regardless of the kind of mobile phone or mobile device. Support for rewards programs and price matching is also desired.

### BRIEF DESCRIPTION OF THE DRAWINGS

FIG. 1 shows a mobile payment system using SMS text messaging.

FIG. 2 is a transaction diagram showing steps in processing a mobile payment using SMS payment-source selection and verification.

FIG. 3 is a block diagram of an SMS mobile payment system.

FIG. 4 is a diagram of a SMS payment system host.

FIGS. 5A-C show SMS text messages being exchanged with the customer's mobile phone.

FIG. 6 shows a screen on a POS terminal that is modified by an SMS payment plugin application that includes a price matching function.

FIG. 7 shows an SMS payment screen.

FIG. 8 is a transaction diagram showing steps in processing a mobile payment using price matching with SMS verification.

FIG. 9 highlights a customer retrieving a rewards card using SMS text messaging.

FIG. 10 is an embodiment of the invention for system for our marketplace.

FIG. 11 is an embodiment of the invention for system for circle of friends and family.

FIG. 12 is an embodiment of the invention for system for security and accounting.

FIG. 13 is an embodiment of the invention for system for circles of friends and family, and their relationships, for multiple members and others.

### DETAILED DESCRIPTION

The present invention relates to an improvement in mobile payment systems. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Most mobile phones in use today support text messaging, such as using the Short Message Service (SMS), which is a common denominator among most mobile phones.

A related application for “Enabling a Merchant's Storefront POS (Point of Sale) System to Accept a Payment Transaction Verified by SMS Messaging with Buyer's Mobile Phone”, U.S. Ser. No. 13/466,435, filed May 8, 2012, describes enhancing the merchant's POS system to use SMS to verify and approve a payment using a traditional payment method, such as a credit card. The credit card information may be stored remotely, allowing the user to make payment to the merchant without showing the credit card to the merchant. Approval by the user is obtained using SMS text messages to the customer's mobile phone.

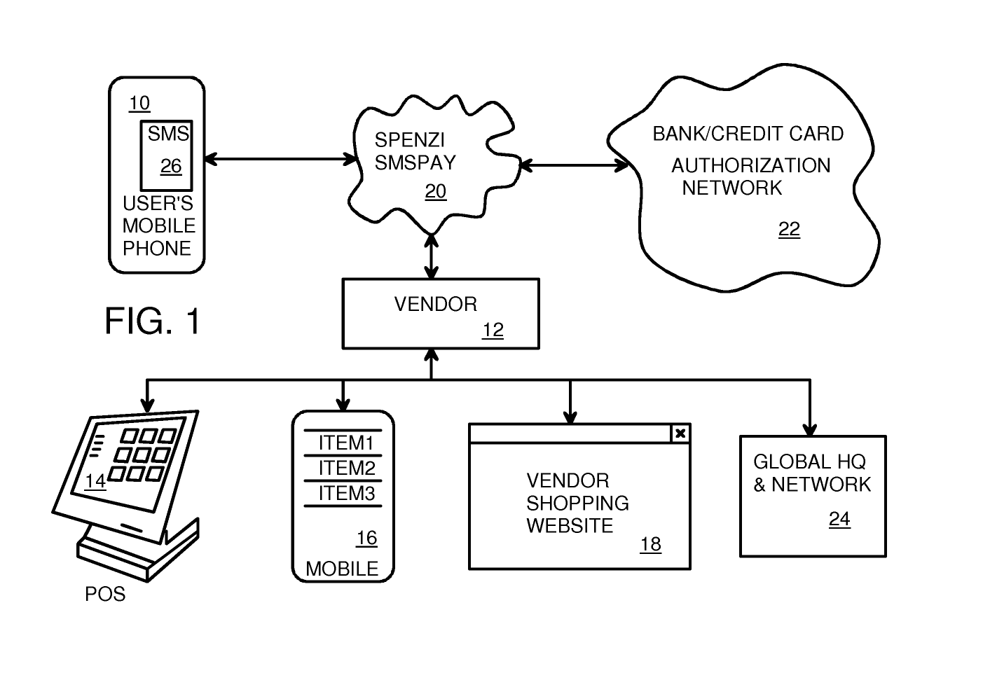

FIG. 1 shows a mobile payment system using SMS text messaging. Vendor 12 has several payment systems, such as POS terminals 14 in physical stores, mobile applications 16 that execute on customers' smartphones, vendors' shopping website 18 that customers can browse to, and vendor network 24 which includes other systems such as at a global headquarters, which may include a phone center that receives orders from customers. These act as POS endpoints.

SMS payment system 20 is a cloud-based service that sends and receives SMS text messages to user's mobile device 10, which includes SMS module 26 for receiving and sending SMS text messages over a cellular or other network.

SMS payment system 20 receives a request from vendor 12 when the customer carrying mobile device 10 initiates a purchase, such as at a checkout stand having a store clerk operating POS terminal 14. SMS payment system 20 sends a SMS message to mobile device 10, and the customer responds to with another SMS text message back to SMS payment system 20 to verify the purchase. Then SMS payment system 20 uses stored credit card or other payment information for this user to authorize payment to vendor 12 using bank authorization network 22.

SMS payment system 20 can operate with many different vendors, and with many different banks and credit card processors. Vendor 12 does not have to handle SMS messages with mobile devices, since these details are handled by SMS payment system 20.

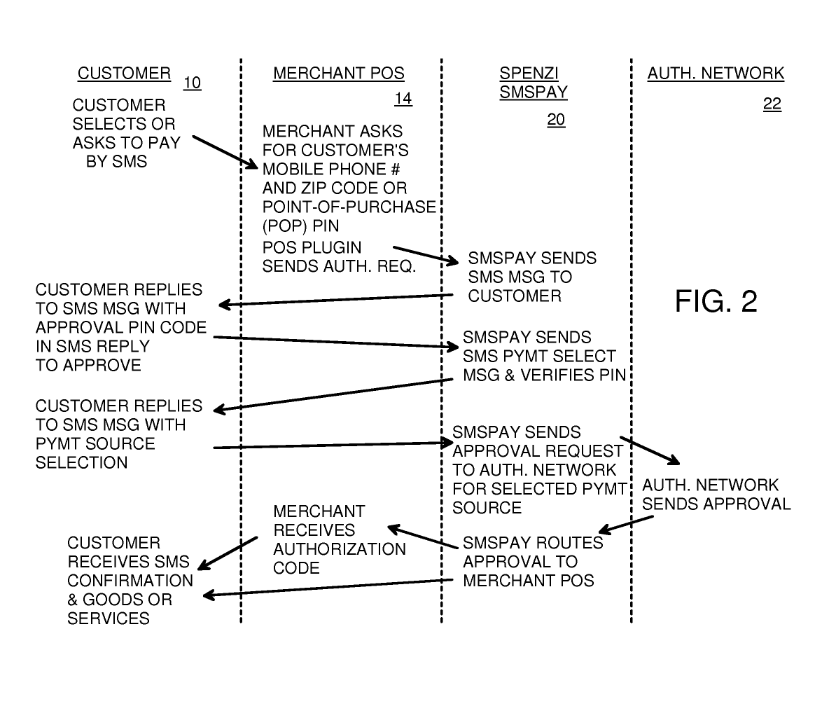

FIG. 2 is a transaction diagram showing steps in processing a mobile payment using SMS payment-source selection and verification. The customer carries mobile device 10, such as a smartphone of any kind, or a legacy cell phone that supports SMS text messaging. The customer selects the merchandise to purchase and asks the store clerk to pay by SMS, or selects SMS by pressing a button on the payment pad by the cash register or checkout stand.

The merchant's clerk asks the customer for the customer's mobile phone number, and the customer's zip code. Rather than use the zip code, the customer may also use a POS Personal-Identification-Number (PIN) that the customer has previously selected. The customer may enter this information on the payment pad, or the store clerk may ask for it and enter it on the POS terminal.

The merchant's POS terminal 14 then sends this information to SMS payment system 20 using a POS plugin app that sends an authorization request to SMS payment system 20.

SMS payment system 20 receives the authorization request from POS terminal 14 and sends a SMS text message over the cellular network to the customer at the customer's mobile phone number. The customer receives the SMS text message, reads it, and replies to this SMS text message with an approval PIN code that the customer had previously selected. The reply SMS text message is sent over the cellular network from the customer's mobile device to SMS payment system 20.

SMS payment system 20 verifies that the approval PIN is correct and sends a second SMS text message over the cellular network to the customer at the customer's mobile phone number. This second SMS message asks the customer to choose a payment source. A list of available credit, debit, and gift cards may be presented to the customer in the second SMS message.

The customer replies to this second SMS text message with a selection of one of the payment sources. The second reply SMS text message is sent over the cellular network from the customer's mobile device to SMS payment system 20.

SMS payment system 20 reads the payment source selected by the customer in the second reply SMS message, and sends an authorization request to bank authorization network 22 for the selected payment source, along with a request to pay the merchant.

The authorization request from SMS payment system 20 is processed by bank authorization network 22, causing a charge to be made to the credit card or other payment selected by the customer in the second reply SMS message, with payment made to the vendor operating POS terminal 14. An approval message generated by bank authorization network 22 is sent back to SMS payment system 20, which routes the approval back to POS terminal 14 along with an authorization code.

SMS payment system 20 also sends another SMS text message to mobile device 10 to tell the customer that the purchase has been approved. The store clerk gives the merchandise to the customer once the approval is received by POS terminal 14 from SMS payment system 20.

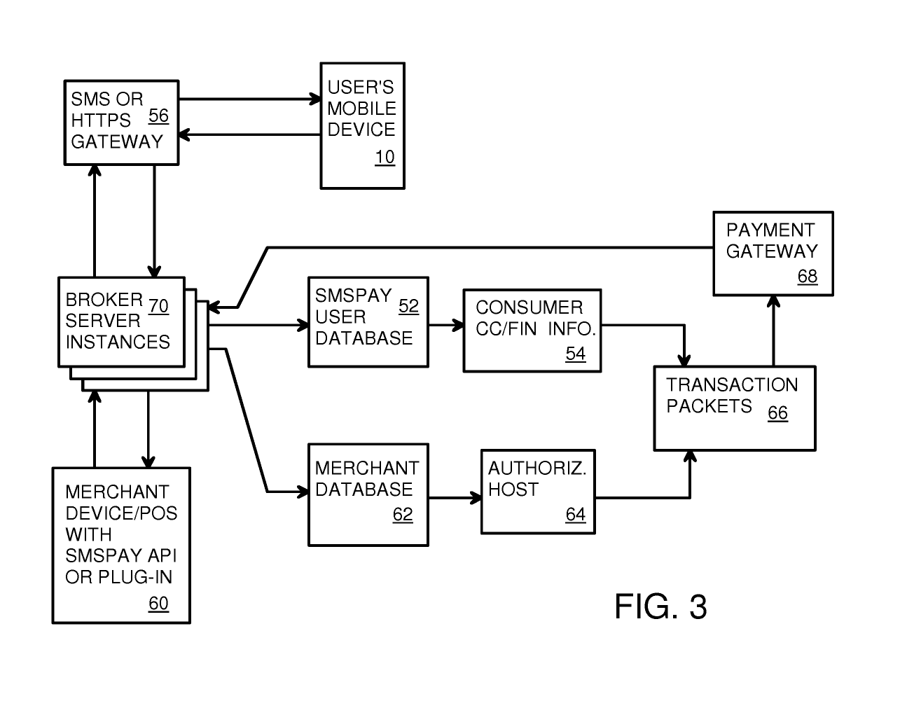

FIG. 3 is a block diagram of an SMS mobile payment system. A customer carrying mobile device 10, such as a mobile phone, has previously registered to use a SMS payment system. The customer's data is stored in SMS payment (SMSpay) user database 52, and includes an approval PIN that the customer selects, and a second piece of information, such as the customer's zip code, or another PIN, the POS PIN, that the user pre-selects. The customer also enters payment information, such as for a credit card, debit card, gift card, etc., which is stored in customer financial information database 54. The customer may select from among these pre-configured payment sources for the second reply SMS message. The customer can enter payment, PIN, and other information at a web site for the SMS payment system, or using a mobile app that links to that website.

A SMS payment (SMSpay) plugin application or other code is installed on merchant POS terminals or merchant POS devices 60. The software on merchant POS devices 60 may be modified using instructions or commands that use an applications-programming interface (API) that connects to broker server instances 70 at SMS payment system 20 (FIG. 2), rather than installing a plugin app.

Broker server instances 70 are created on the servers at SMS payment system 20 to process payment requests from merchants. Broker server instances 70 parse the incoming requests from merchant POS devices 60 for the customer's mobile phone number, and lookup this phone number in SMSpay user database 52, and verify that the correct zip code or POS PIN is included in the requests. Broker server instances 70 then create text messages that are sent to mobile device 10 after being formatted as an SMS message by SMS gateway 56. When mobile device 10 is a smartphone configured properly, SMS gateway 56 may instead send text messages using a Secure Hyper-Text Transfer Protocol (HTTPS) connection that sends and receives Transport-Control-Protocol Internet Protocol (TCP/IP) packets with mobile device 10 over a cellular or other data network.

The reply SMS text messages or HTTPS connection messages are received from mobile device 10 by SMS gateway 56 and passed on to the requesting one of broker server instances 70. The reply text message contains the approval PIN that the customer entered on mobile device 10, or the payment source selection. Broker server instances 70 match that approval PIN from mobile device 10 with a stored approval PIN in SMSpay user database 52 that the customer previously selected and stored. For the second reply text message, broker server instances 70 select one of the pre-configured payment sources.

Broker server instances 70 create transaction packets 66 once the customer's approval PIN is matched and the payment source selected. The customer's payment information for the selected payment source from customer financial information database 54 is combined with the merchant's information from merchant database 62 to form transaction packets 66. The merchant's information may include pre-configured settings for a payment gateway that are provided by authorization host 64, which may be a third-party payment processor, bank, or other financial or merchant institution. Broker server instances 70 may use the merchant's identifier from the request from merchant POS devices 60 to lookup merchant information in merchant database 62, and this merchant information is then sent to authorization host 64 and the reply data from authorization host 64 then merged into transaction packets 66 that are sent on to payment gateway 68.

Transaction packets 66, which consist of detailed financial information such as cardholder data and authentication data, stored in database 54, are sent to payment gateway 68. Payment gateway 68 processes the payment requests and responds with authorization codes and indicates that the transaction is completed, or with an error code.

Broker server instances 70 receive the authorization code from payment gateway 68 for the request, and send an approval message to merchant POS devices 60 and to mobile device 10 through SMS gateway 56.

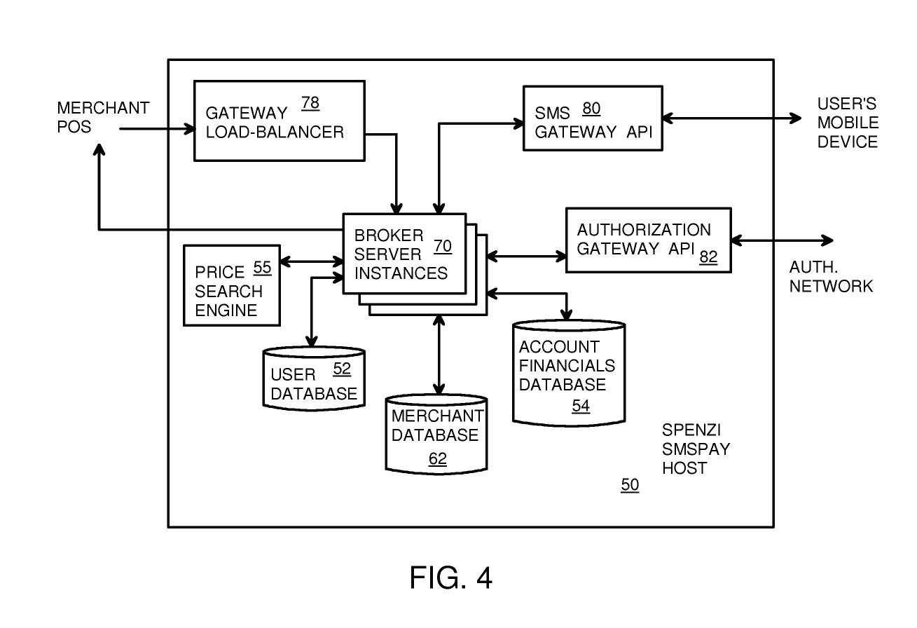

FIG. 4 is a diagram of a SMS payment system host. SMS payment host 50 has SMSpay user database 52 that is populated with user records when a customer registers at a web site and enter his mobile phone number, mailing addresses, zip code (or POS PIN), and approval PIN. Merchant database 62 is populated by merchant records for merchants that have installed SMS payment plugin apps or other code to accept payment through SMS payment host 50. Customer financial information database 54 contains the detailed financial information obtained when customers register, such as the credit card numbers, expiration dates, and billing addresses. A list of payment sources may be kept in SMS user database 52 without the secure card numbers, while the secure card numbers are kept in customer financial information database 54. Links in SMS user database 52 may point to the cards stored in customer financial information database 54. Additional levels of security such as encryption may be used to store data in customer financial information database 54 than with SMSpay user database 52.

Incoming requests from merchant POS terminals and other merchant devices are load-balanced by gateway load-balancer 78 and assigned to instances in broker server instances 70 for processing. Text messages to customer mobile phones and other mobile devices that are generated by broker server instances 70 are formatted as SMS messages using SMS gateway API 80. HTTPS connections may be used in place of SMS and issued and then received by broker server instances 70. SMS reply messages from customer mobile devices are returned using SMS gateway API 80 to broker server instances 70.

Payment request packets to the authorization networks or gateways are created by instructions executed by broker server instances 70 that use authorization gateway API 82. Different merchants may require that broker server instances 70 send requests to different authorization networks or payment processors who use different API's.

Price search engine 55 is activated by broker server instances 70 when a POS terminal 14 activates a price search function. Price search engine 55 receives item information from POS terminal 14, such as a UPC code or a description, and searches other store databases on the Internet to find matching items, and reports back to POS terminal 14 the prices found. Alternately, the customer could activate price search engine 55, such as by using additional SMS messages during the purchase transaction, or by pre-configuring price matching, with the report being sent to the customer's mobile device 10.

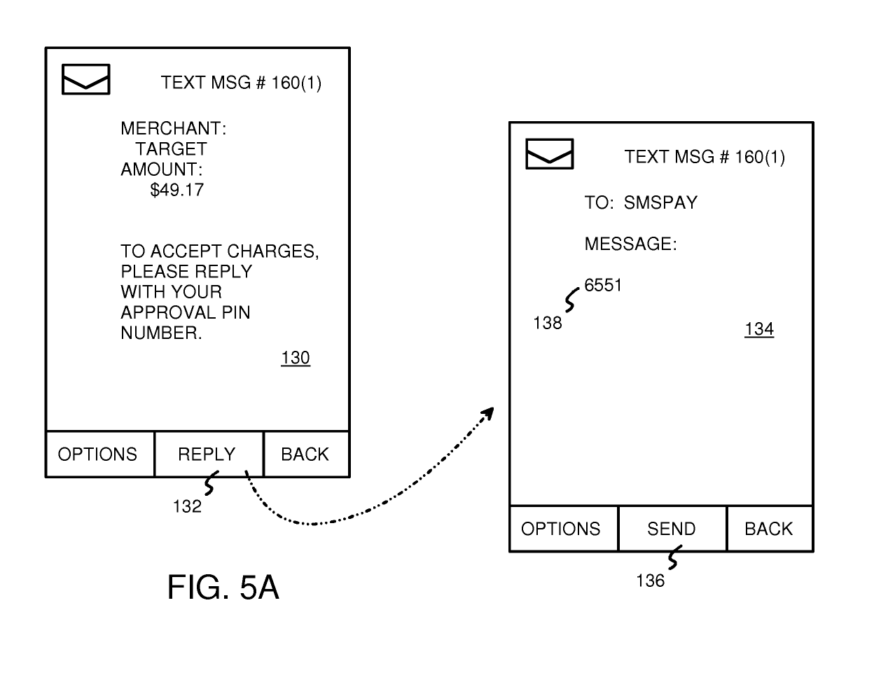

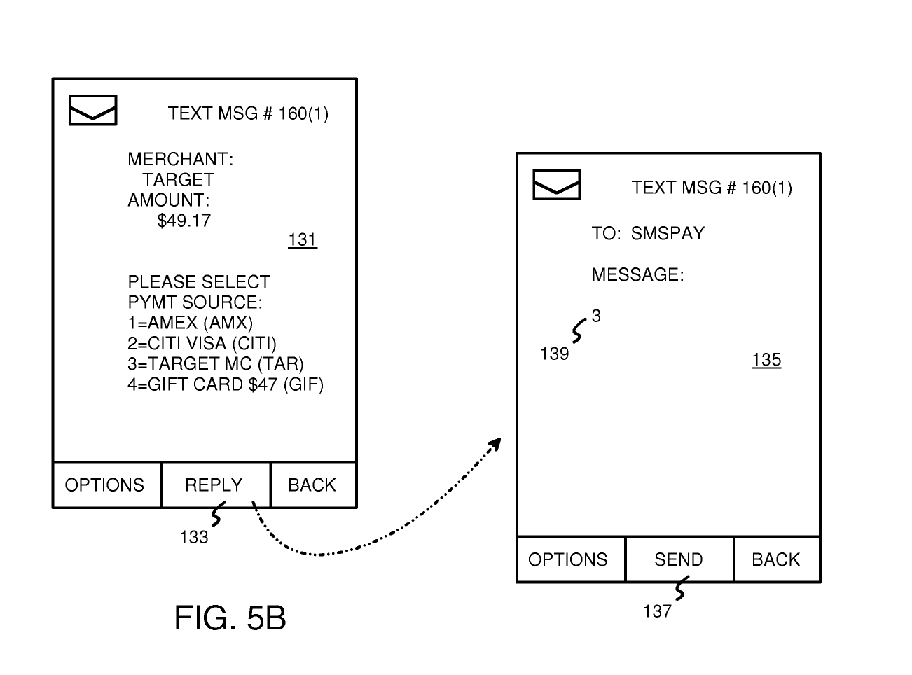

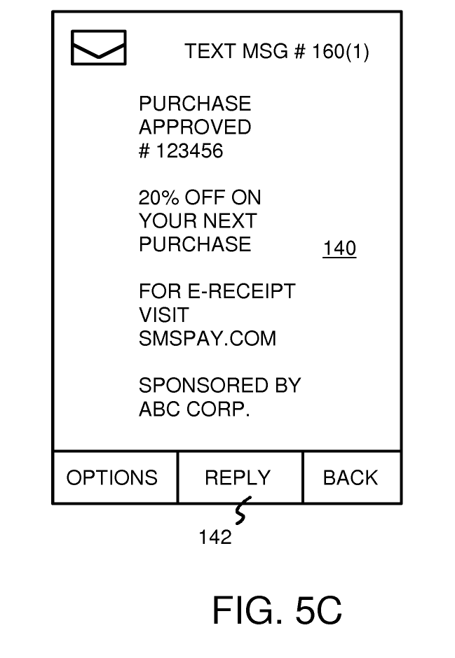

FIGS. 5A-C show SMS text messages being exchanged with the customer's mobile phone. In FIG. 5A, SMS text message 130 is sent from SMS payment system 20 to the customer's mobile device 10 and displayed on the phone's display to the customer.

The text message shows the amount, merchant's name, and a message to reply with the approval PIN to accept the charge. The customer then presses reply button 132 on mobile device 10 and types in approval PIN 138. The customer's approval PIN 138 is entered as “6551” by the customer typing in these 4 digits using a key pad on mobile device 10. The key pad may be an alphanumeric keyboard that is displayed on the display screen of mobile device 10, or may be physical telephone number keys on mobile device 10. Then the customer presses send button 136 to send reply SMS text message 134 back to SMS payment system 20.

In FIG. 5B, second SMS text message 131 is sent from SMS payment system 20 to the customer's mobile device 10 and displayed on the phone's display to the customer. The second text message again shows the amount and merchant's name, but also has a list of available payment sources. The customer then presses reply button 133 on mobile device 10 and types in a selection of the payment source.

For example, the payment sources may be displayed as a numbered list in second SMS text message 131, and the customer may select a payment source by typing in the number for the desired payment source. The customer's selected payment source 139 is entered as “3” by the customer typing in this digit using a key pad on mobile device 10. Then the customer presses send button 137 to send second reply SMS text message 135 back to SMS payment system 20.

Alternately, the payment sources could be associated with nicknames, such as “TAR” for target credit card. The customer could type in one of these nicknames as selected payment source 139 rather than the number of that payment source. Although this requires more keystrokes, some customers are quite handy with texting and may prefer to use a nickname, especially if the numeric listings were to change, such as when the pre-configured cards are added or deleted.

In FIG. 5C, the approval PIN from the customer has been matched to the customer's record by SMS payment system 20 for approval, and the payment source selected by the customer was used to generate one or more transaction packets that were sent to the bank authorization network to obtain an approval code. SMS payment system 20 sends another SMS text message to the customer's mobile device 10. Approved message 140 indicates that the purchase was approved. Other information may be included in approved message 140, such as an advertisement, or a discount code or other information for a future sale. Reply button 142 may be used in some embodiments for the customer to obtain the future discount, or to get more information.

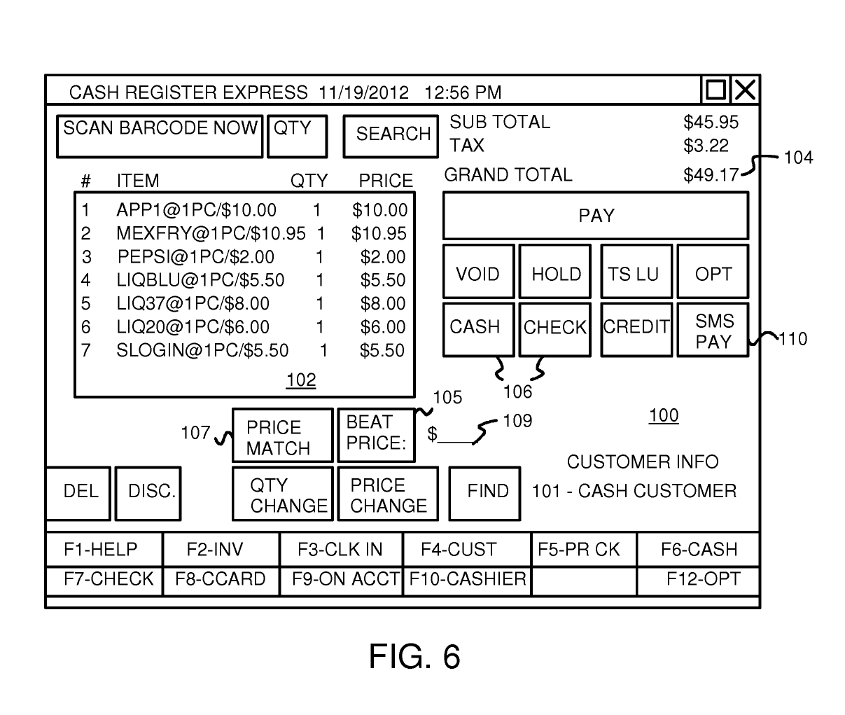

FIG. 6 shows a screen on a POS terminal that is modified by an SMS payment plugin application that includes a price matching function. Payment screen 100 is shown on POS terminal 14 (FIG. 1) for the store clerk to operate. Bar codes on items being purchased may be scanned and a list of items 102 displayed, along with a grand total 104. Payments by cash or check are made by pressing payment buttons 106. Credit cards may also be accepted by pressing the credit button.

The store clerk may select one of the items displayed in list of items 102 and then press price match button 107. Price search engine 55 is activated to search for matching items in one or more databases, or on the Internet. A cloud-based server may be used for searching. The lowest price found for the item is displayed in a pop-up window or on payment screen 100 (not shown). The store clerk (or an automated system) may then press beat price button 105, and enter a new price for the item into new price field 109. The item's price is then updated in list of items 102. The price matching process may be repeated for other items, or all items may be checked at the same time using an expanded price matching function. The store clerk may inform the customer of the new price due to price matching to increase store loyalty. The store having the lowest price may also be displayed, or recorded for future analysis.

An additional payment button is displayed for making payments by SMS. SMS pay button 110 is displayed alongside other payment buttons. The SMS payment plugin application modifies payment screen 100 to show SMS pay button 110.

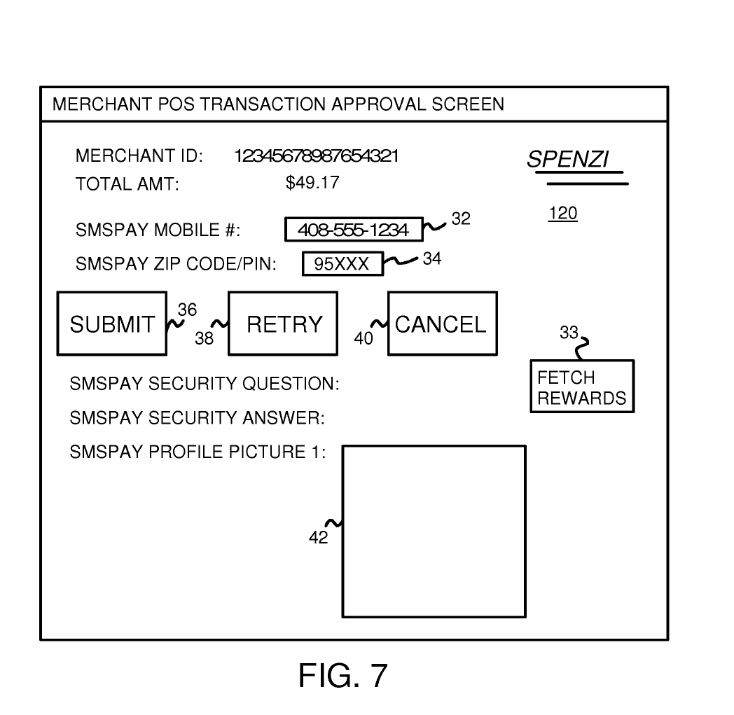

FIG. 7 shows an SMS payment screen. When the store clerk presses SMS pay button 110 on payment screen 100 (FIG. 6), SMS payment screen 120 is displayed on POS terminal 14. The store clerk asks the customer for his or her mobile phone number, which the store clerk types into phone field 32. In some embodiments, the store clerk also asks for the customer's zip code or POS PIN, which the store clerk types into zip code field 34. When the store clerk presses submit key 36, a request is sent to SMS payment system 20. The store clerk may also cancel the payment using cancel key 40 or retry using retry key 38.

SMS payment system 20 may display a security question and answer at SMS payment screen 120 for the store clerk to ask the customer. A picture of the customer may also be displayed in frame 42 for the store clerk to verify the customer. This information may be displayed while SMS payment system 20 is sending the SMS text message to the customer while the store clerk is waiting for approval.

The store clerk may press fetch rewards button 33 on SMS payment screen 120. The customer may belong to a rewards program for the merchant. For example, the customer may be entitled to a 5% discount due to a rewards program. A rewards fetch message is sent from POS terminal 14 to broker server instances 70, and a lookup of the customer's record is performed in SMS user database 52. If a matching rewards programs that is valid for the current merchant is found, a rewards reply message is sent back to POS terminal 14. Then POS terminal 14 may apply the reward, such as by reducing the amount due shown on payment screen 100 (FIG. 6).

The rewards may also be points that are accumulated for each purchase, in which case pressing fetch rewards button 33 causes the point balance for the customer to increase once the current purchase is completed. Many other types of rewards and variations are contemplated, such as additional free items, free upgrades, concierge service, etc.

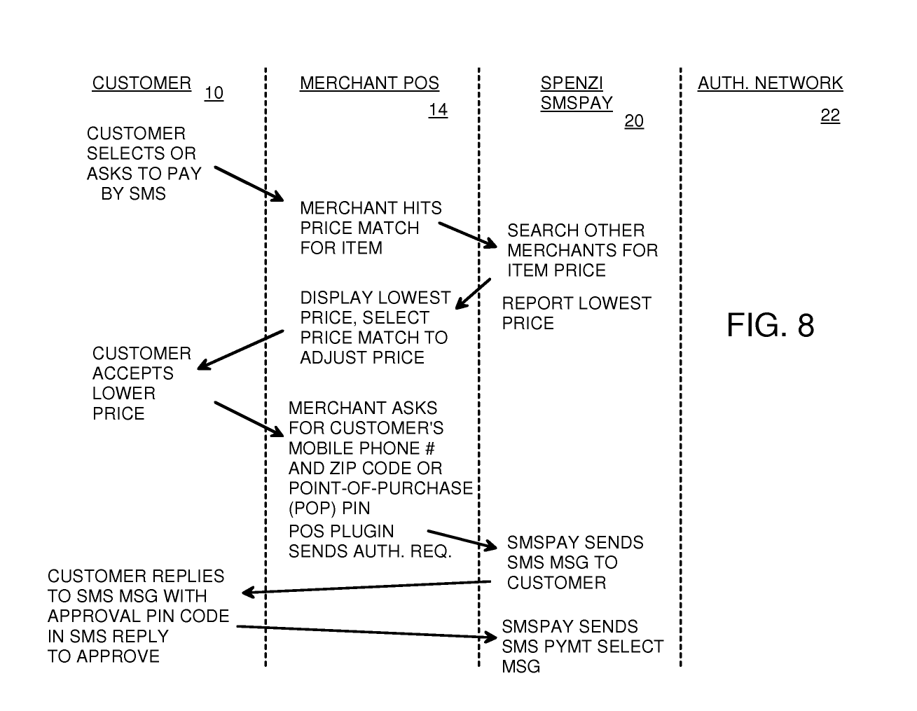

FIG. 8 is a transaction diagram showing steps in processing a mobile payment using price matching with SMS verification. The customer carries mobile device 10 and selects the merchandise to purchase and asks the store clerk to pay by SMS, or selects SMS by pressing a button on the payment pad by the cash register or checkout stand.

The merchant's clerk presses the price match button on payment screen 100 (FIG. 6). Price search engine 55 is activated by broker server instances 70 at SMS payment system 20 and a price search is performed. The lowest price is found by the search and reported back to POS terminal 14.

The merchant's clerk sees the lower price displayed on payment screen 100 or in another window and decides to match or beat the price. The merchant's clerk presses the price beat button on payment screen 100 and enters a new price, or accepts the lower price. The merchant's clerk informs the customer of the new lower price due to the price matching feature. The customer accepts this lower price for the item or items.

The process then continues as described earlier in FIG. 2. The merchant's clerk asks the customer for the customer's mobile phone number. The customer enters this information, and POS terminal 14 sends this information to SMS payment system 20 using a POS plugin app that sends an authorization request to SMS payment system 20. The customer receives the SMS text message, reads it, and replies with an approval PIN code. Other steps continue as described for FIG. 2.

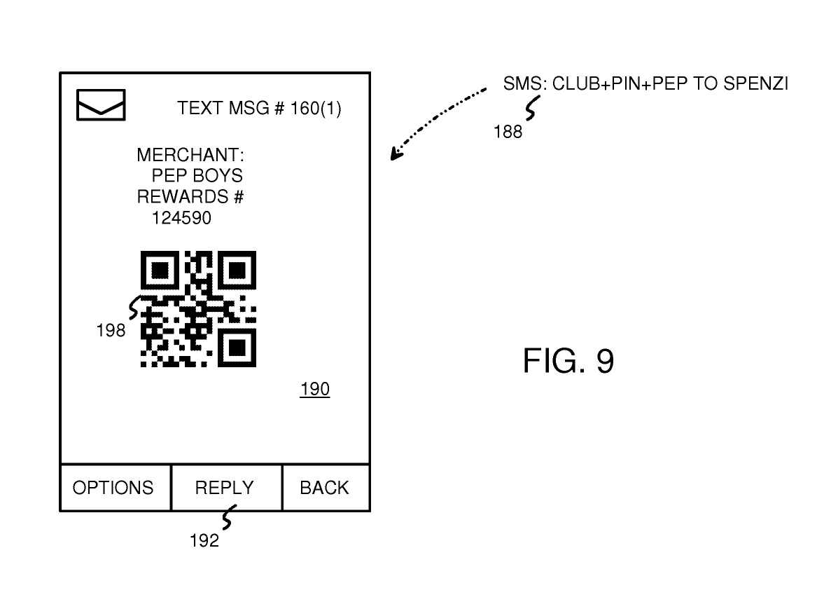

FIG. 9 highlights a customer retrieving a rewards card using SMS text messaging. The customer is at a store but does not have a rewards card for that store with him. The rewards card information is stored with his account at SMS payment system 20, such as in SMS user database 52.

The customer sends a text message to SMS payment system 20 to retrieve a copy of the rewards card. The customer texts a combination of a keyword (“CLUB”), his PIN, and the nickname of the rewards card (“PEP”). Text request message 188 is sent from the customer's mobile device 10 to SMS payment system 20. SMS payment system 20 responds by looking up the customer's mobile phone number (obtained as the source of text request message 188) in SMS user database 52.

Once a matching customer record is found in SMS user database 52, SMS payment system 20 verifies the customer's PIN, and then searches the customer's record for reward cards, and finds a reward card for Pep Boys that has a nickname of PEP. SMS payment system 20 could also perform a best match of all reward cards, and find the PEP is a fragment of the full name of the reward card for PEP Boys.

SMS payment system 20 generates rewards text message 190 that is sent to mobile device 10. The name of the rewards card and the rewards account number are shown in rewards text message 190. Image 198 may be attached to rewards text message 190. Image 198 is a QR code for the rewards card that the merchant's store clerk may scan with his checkout scanner. The customer may show image 198 to the store clerk, who scans the QR code displayed on mobile device 10. Thus the customer obtains the rewards credit although he forgot to bring his actual rewards card.

The customer could obtain other information from SMS payment system 20 in a similar way. Text request message 188 could have another keyword such as RECEPIT to request a copy of a store receipt for a prior purchase, along with the name of the store and perhaps the date of purchase or an item purchased. SMS payment system 20 could respond with a copy of the store receipt, and image 198 could be a QR code from the store receipt that a store clerk could then scan to locate the receipt on the merchant's computer. Retrieving a receipt could be useful for store returns or warranty repairs. An app on mobile device 10 may also be used to retrieve information. SMS messages with a list of available receipts or reward cards could also be exchanged with mobile device 10.

### ALTERNATE EMBODIMENTS

Several other embodiments are contemplated by the inventors. While image 198 being a QR code has been described, image 198 may be a bar code or other machine-readable or scannable image. While exchanging SMS messages to select the payment source has been described, the selection of payment source could also occur using POS terminal 14, such as by the store clerk asking the customer to select a payment source listed on POS terminal 14, or on a customer display screen attached to POS terminal 14. Merchants may be able to disable SMS verification, such as for low-risk or low-price transactions. The customer could be allowed to enter his mobile phone number and PIN on a customer display screen attached to POS terminal 14. Certain payment sources may be pre-assigned for certain merchants, allowing the customer to skip exchanging SMS messages to select the payment source.

Rewards cards could also be pre-linked to certain merchants. Rewards may include percentage-off discounts, dollar off discounts for certain items or for any item, free merchandise, upgrades, etc. Merchants may accept rewards cards for other merchants as well as their own reward cards. Rewards card numbers or account numbers could also be read from SMS user database 52 or linked to SMS user database 52 and reported back from SMS payment system 20 to POS terminal 14 or to other computer systems for the merchant. Some merchants may have their own smartphone apps that may be able to access SMS payment system 20 or may be able to substitute for the text messages exchanged for verification. For example, the customer could type in his approval PIN on the merchant's smartphone app.

Rather than display a list of payment sources, second SMS text message 131 could just ask the customer to select a payment source without listing those sources. The customer would have to remember the nicknames for his payment sources. This non-display of payment sources could increase security.

SMS payment system 20 may be used with an online auction system. Customers could configure their auction service to post messages on social networks sites indicating that the customer has bid on a certain item. Rewards could be accumulated for such bid-and-post messages. Such social networking messages could also be automatically generated when making a purchase using SMS payment system 20, whether an in-store purchase or an online purchase or from an online auction Links to the product page for the item purchased or bid on may be provided in the social networking messages, allowing other users to click on the links and buy the same item.

Many variations of display screen 100 of POS terminal 14 are possible, and for other displays and web pages and messages shown in the drawings. While SMS payment system 20 using SMS text messaging has been described, SMS payment system 20 may use HTTPS or Hyper-Text-Markup-Language version 5 (HTML5) or later when connecting to some advanced smartphones or other mobile device 10. SMS payment system 20 may have the ability to use SMS for older mobile phones, and more advanced and secure connections that feature handshaking and packet exchange with more advanced mobile devices. Encryption keys may also be exchanged in some of these advanced connection methods. For example, a 256-bit encryption scheme may be used.

While POS terminal 14 has been described as being operated by a store clerk or employee, some POS terminals 14 may be self-serve and operated by the customer. Other POS terminals 14 may have the customer enter information on a small keypad so that the store clerk does not see this information, such as a POS PIN. POS terminal 14 could also be located at a call center where the customer is not physically present, or be part of an online store, such as part of a checkout shopping program. POS terminals traditionally have a drawer for accepting cash, and are a replacement for a cash register.

POS terminal 14 could be on a mobile device such as a tablet, mobile phone, or other mobile device. POS terminal 14 could be a game console, a smart refrigerator or other smart appliance, a gasoline pump, a smart TV, a set-top box, a GPS device, a WiFi router, a tablet, a laptop, a camera, any video-based interface system, an audio system with some interface to purchase, any Internet device with a screen, or any connected device with a remote web interface/software interface. The generic term POS endpoint is intended to include POS terminals 14, whether traditional stationary cash registers, mobile tablets or other devices that a store clerk carries around a store, mobile applications that execute on customers' smartphones, vendors' shopping websites that customers can browse to, and the vendor network which includes other systems such as at a global headquarters, which may include a phone center that receives orders from customers.

While the customer either verbally telling the sales clerk or manually typing in the customer's mobile phone number and zip code or POS PIN has been described, voice recognition software could be used to capture the information. A random or other security question could be asked of the customer, either in place of the zip code or in addition to the zip code. Some embodiments may rely on only the mobile phone number, not a zip code or second piece of information from the customer. Some advanced smartphones may be detectable by POS terminal 14, such as over a wireless network, and this could be an additional factor for verification. The SMS payment system could be used in combination with other security and payment systems.

If the zip code or POS PIN does not match, SMS payment system 20 could initiate a voice call to mobile device 10 and have an operator or a computerized system ask the customer for additional or backup verification. This additional verification could also be sent by SMS text messaging, email, or other methods. These phone calls could be recorded.

If verification fails, the purchase is blocked. The customer could be notified by other means that does not rely on the physical possession of mobile device 10, such as email, a call to a home phone or to a friend's phone, and/or mail. A security group at SMS payment system 20 or a bank or credit card company could also be notified, as could the cellular carrier. An SMS message indicating that the purchase has been declined may also be sent, either when the approval PIN is not matched, or bank authorization network 22 fails to authorize the charge, such as for insufficient credit or funds. Various steps may be repeated for a fixed number of times, such sending the SMS message again if the customer mistakenly types in the wrong approval PIN.

While the customer replying to the SMS text message with her approval PIN has been described, the customer could also be asked to answer a multiple-choice security question, enter some other piece of information, or even reply with a random code that is part of the SMS text message. For example the SMS text message could say “reply with code 5251”. The customer then replies with a text message saying “5251”.

SMS payment system 20 has the merchant install a plugin application on POS terminal 14 or otherwise modify its software. However, the customer does not have to install any software on mobile device 10. The customer only has to link his mobile phone number to his payment method and provide verification information. The customer may do this by logging on to the web site for SMS payment system 20, or its parent company, or a business partner's web site that provides this linking. The customer could call in to a call center to register and link his phone number and provide payment and verification information over the phone, or even in person at a store, such as at POS terminal 14. The customer could also use a smartphone application that uses HTML5 or HTTPS to register for, configure, and monitor use of SMS payment.

Payment sources could include credit cards, debit cards, gift cards, checking accounts or other bank or brokerage accounts, various merchant programs such as reward points programs or loyalty programs, or any other money or quasi-money source. The user may define nicknames for payment sources and configure rules for selecting payment methods, such as to use a particular card at a particular merchant, default cards, backup cards, etc. The SMS payment configuration web site could provide a list of all merchants accepting SMS payments, allowing the customer to configure various cards or payment sources for various merchants. Some merchants may offer discounts or other incentives, or display advertising to the customer on the SMS payment web site. Various menus or dialog boxes may be used to assist the customer in configuring payment sources and rules.

Registered customers may suspend payments by SMS payment system 20. The customer could telephone a call center for SMS payment system 20 to request suspension of a particular transaction, or to suspend all transactions, such as if mobile device 10 is lost. The customer could also suspend transactions by logging on to the SMS payment system website and selecting a suspend transaction feature. In some embodiments the customer may be able to suspend transactions at POS terminal 14 by telling the store clerk, who uses the SMS payment plugin application to suspend the customer's SMS pay account. The customer could also send a specific trigger code by SMS to SMS payment system 20 that causes the account to be frozen immediately.

While SMS payment system 20 creating transaction packets of a request to bank authorization network 22 have been described, SMS payment system 20 could notify the merchant of authorization by SMS, send the customer's payment information, and then allow the merchant to directly process the transaction with bank authorization network 22. Several variations of authorization are possible. The merchant may handle authorization with the bank or financial network, and merely use the SMS payment system to exchange SMS text messages with the customer for verification, with the customer still providing a copy of his credit card to the merchant. In this variation, the SMS payment system is simply an additional verification method. Alternately, the SMS payment system could send the customer's payment information to the merchant rather than to the authorization network, or could provide this information to a third party who then combines the customer's payment information with information from the merchant before sending the authorization request to the authorization network. The authorization network itself may be quite complex with several intermediate steps and processes.

A customer could be a retail shopper, an online shopper, a wholesale purchaser, a program or application user, or other purchaser of goods, services, or software. The customer's phone number and zip code or POS PIN could be encrypted for transmission from POS terminal 14 to SMS payment system 20. Other messages could also be encrypted, partitioned, scrambled, or otherwise modified. SMS payment system 20 could further verify that the SMS reply message is from the customer's mobile device 10 by matching the user's mobile phone number in the reply SMS message, or by matching text copied in the reply SMS message from the original SMS text message sent to the customer.

Many variations of the SMS text messages are possible, and various combinations of messages and replies are possible. While SMS has been described, HTTPS or other mobile protocols and applications may be substituted. Multimedia Messaging Service (MMS) or other protocol messages with graphics, audio, or video may be substituted for SMS.

There may be several payment sources for a customer that may be stored in one or more store credit queues that are processed in a pre-defined order, such as using store vouchers, then gift cards specific to that merchant, then more general gift cards, then a debit or credit card.

Store vouchers or credits may be purchased at a discount to face value. A third party such as an advertiser, a non-profit group such as a school booster club, consolidator, or other third party may also receive a credit when the store voucher is purchased or otherwise obtained. Non-profits can sponsor campaigns to get consumers to purchase store vouchers, with a portion of the store's proceeds going back to the non-profit. Other variations of giveback initiatives may be substituted.

Deal sharing could operate on store vouchers, credits, gift cards, discounts, sales, or other promotions that function as “deals” that are shared among a group of customers in a grouped account, or customers that link to each other or otherwise offer to share their deals. A customer could also receive a hardcopy deal, such as on a flyer or cash register receipt, or could view a similar deal on a poster at the store, online, on TV, or by other advertising. A code printed on the displayed or hardcopy deal could be sent to the SMS control system, such as by a SMS text message, or by entering the hardcopy deal code on the web site for the SMS control system. The hardcopy deal code could be looked up by the broker server instances and a store credit or deal created for the customer. The created credit or deal could then be shared with other customers, such as by being entered in Customer A's store credit queue and Customer B's store credit queue. A third party service could also collect such deals and share them with customers.

While SMS-verified purchases have been described, SMS verification may also be used for activating physical devices such as Automated Teller Machines (ATMs). The customer could avoid carrying an ATM card and instead activate a SMS-control API executing on the ATM machine. The customer could type in his phone number into the ATM or perhaps use NFC and tap his phone.

In some embodiments, the POS terminal will also allow the customer to enter his approval PIN, and the SMS verification skipped. Of course, this has lower security and may not be implemented in other embodiments requiring better security. This is useful for when the customer does not have his phone. The merchant could also ask the customer to select the payment source from among a list provided by SMS control system 20. The customer could also have pre-configured trigger code names for each payment source, such as “biz visa” that the store clerk could enter into the POS terminal. The payment source could also be selected by exchanging another set of SMS messages when the customer is using his mobile device.

Purchases could be shipped to the customer using a pre-defined shipping address in SMS user database 52. While separate SMS messages for the approval PIN and for the selection of the payment source have been described, these messages could be combined, having the user reply with both his PIN and the payment source selection.

Most mobile devices have a unique identifier such as an International Mobile Equipment Identity (IMEI) number, which is a 15-digit serial number, and/or an International Mobile Subscriber Identity (IMSI), which is a 64-bit field store on the Subscriber Identity Module (SIM) card inside the mobile device. Mobile device 10 must use these unique identifiers to make a call over a cellular network. An encryption key may be used that is related to these unique identifiers. When a mobile phone is lost or stolen, these numbers may be placed on a black list to prevent their use. Thus mobile device 10 contains security features that are intended to quickly deactivate stolen phones.

SMS control system 20 may be configured to only send SMS text messages to valid phone numbers. SMS module 26 is an SMS application that sends SMS text messages over the cellular network, and excludes third party software such as text-messaging applications that execute on smartphones and PC's. These third-party applications are excluded since they allow the user to create an email address to receive text messages, and these email addresses are not necessarily the customer's mobile phone number. Thus SMS module 26 uses the customer's mobile phone number to receive SMS messages. Some smartphones may allow text messaging or other messaging by several methods, such as over a WiFi/cellular data network (such as Google Voice). These programs may include SMS module 26 that sends standard SMS text messages over the cellular network as a sub-set of their features. SMS control system 20 only communicates using standard SMS text messaging, or using a secure HTTPS connection that can be validated with the customer's mobile phone number, such as an HTTPS connection that can only operate on mobile device 10, not on PC's or other devices.

SMS control system 20 sends text messages to mobile device 10 when mobile device 10 has not been deactivated or blacklisted by the cellular carrier. SMS control system 20 inherently verifies the customer's mobile phone number since only that unique mobile device 10 can receive those SMS text messages, or receive an HTTPS connection from SMS control system 20. The reply SMS text message with the approval PIN must have been sent from mobile device 10, operating with an IMSI, IMEI, or other device identifiers.

When mobile device 10 is a smartphone configured properly, SMS gateway 56 may instead send the text message using a Secure Hyper-Text Transfer Protocol (HTTPS) connection that sends and receives Transport-Control-Protocol Internet Protocol (TCP/IP) packets with mobile device 10 over a cellular or other data network.

There may be two factors of authentification required, in addition to the customer's phone number. The correct zip code (or POS PIN) must be entered at a POS terminal, and the correct approval PIN must be sent as a SMS text message from mobile device 10.

The primary customer on a grouped account could be notified by SMS text message when another sub-user makes a purchase. The grouped account could be configured so that purchases above a specified dollar amount must be approved by the primary customer while purchases below the specified dollar amount may be approved by a sub-user. Parents could allow some purchasing below a specified limit for children using this feature. The primary customer could approve the sub-user's purchase by replying with the primary customer's approval PIN. SMS control system 20 could require both the primary customer and the sub-user to reply to SMS messages before the purchase is approved.

The background of the invention section may contain background information about the problem or environment of the invention rather than describe prior art by others. Thus, inclusion of material in the background section is not an admission of prior art by the Applicant.

Any methods or processes described herein are machine-implemented or computer-implemented and are intended to be performed by machine, computer, or other device and are not intended to be performed solely by humans without such machine assistance. Tangible results generated may include reports or other machine-generated displays on display devices such as computer monitors, projection devices, audio-generating devices, and related media devices, and may include hardcopy printouts that are also machine-generated. Computer control of other machines is another tangible result.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

In one embodiment, for a given person, any member and his/her circle of family and friends that singed up to be contributor to him/her, and shop at the school Koincloud Marketplace, for products and services, through our web site, would be able to get 5 (or R) percent of the sales proceed go to his child's tuition or school related expenses or supplies or sports (or split further in smaller proportions or percentages, e.g. 1 percent), and %5 (P percent) goes to school for fundraising.

In one embodiment, for a given person, for any member and his circle of family & friends that singed up to be contributor to him, and shop at the School Koincloud Marketplace, %5 (or R) of the sales proceed would go to school and other %5 (or e.g., P percent) would go toward his/her mortgage.

In one embodiment, for a given person, for any member and his circle of family & friends that singed up to be contributor to him, and shop at the School Koincloud Marketplace, %5 (or R) of the sales proceed would go to school and another %5 (or e.g., P percent) would be paid towards his/her student or kid's student loan.

In one embodiment, for a given person, for any member and “his circle of family & friends” that singed up to be contributor to him, and shop at the university Koincloud Marketplace, nominated by him or signed up as proxy for him, or authorized by him, or using his guest account or password, then %5 (or R) of amount he/she shopped from Koincloud Marketplace would go to his university and another %5 (or e.g., P percent) would go towards his university tuition or private high school tuition or sports events or school theater or the like.

In one embodiment, for a given person, the person identifies a second person from his circle of friends and circle of family, as one or 2 separate groups, to be able to come in as a guest, or some flagged people can come in, or all people can come in, as subset, as guests for his contribution to give money or buy objects or services, or getting awards or money back or discounts or coupons or points on his behalf, as beneficiary of the Koincloud Marketplace, directly benefiting from the deal or setup or arrangements.

In one embodiment, for a given person, the person identifies a friend as guest, and then the guest can become a member, and this can go on as tree structure, and a person bringing a friend gets a percentage of the deal for friend and future friends, and although it is a small percentage, T, or 0.1 percent, but can add up to a large amount for many friends bringing more friends in the circle, of the first member, or friends of friends, or circles of circles, as it can grow very big very fast, exponentially. So, for example, the 1^{st} person gets T percent of the deal from 1^{st} friend, and the first friend gets T or T1 percent, same or a different percentage, e.g., 0.15 percent, of the deal from his own 1^{st} friend, e.g., call it the second friend, and so on. So, it can continue like a tree structure, which grows fast, to encourage self-marketing from grass root, with huge income and membership and fast membership growth rate. Then, we have, for the first person, based on friend of friend of friend:

G=(G1·T)+((G2·T1)T)+(G3·T2·T1·T)+ . . .

Wherein Gi indicates the amount of deals for transaction for e-commerce for objects, purchases, leases, rents, or services/fees. Ti indicates the percentages for each friend or individual. T is the original percentage for the first friend. G is the total benefit through these transactions added for a first member, to be given to him at the end of pay period of e.g. month or week or year or quarter, which goes to each branch of friends to add all of them, as summation of summations. This is the total for that person. However, each person in the circle has her own sum and running total, to be awarded. This encourages more marketing and adding more friends. This shares benefit to friends and especially for first members joining sooner.

In special case, for equal Ti equal to T, we have:

G=(G1·T)+(G2·T²)+(G3·T³)+ . . .

In one embodiment, for a given person, the person may nominate a guest Q and another person do the same for Q, and then, they both nominators share the benefit equally, e.g., ½ or 0.5:

G=0.5{(G1·T)+((G2·T1)T)+(G3·T2·T1·T)+ . . . }

Or in special case above, we have:

G=0.5{(G1·T)+(G2·T²)+(G3·T³)+ . . . }

In one embodiment, for a given person, such formulas work for contributions/giving/purchases, too, to propagate the partial effect of friends on original member, to increase effective percentage or rate or benefit.

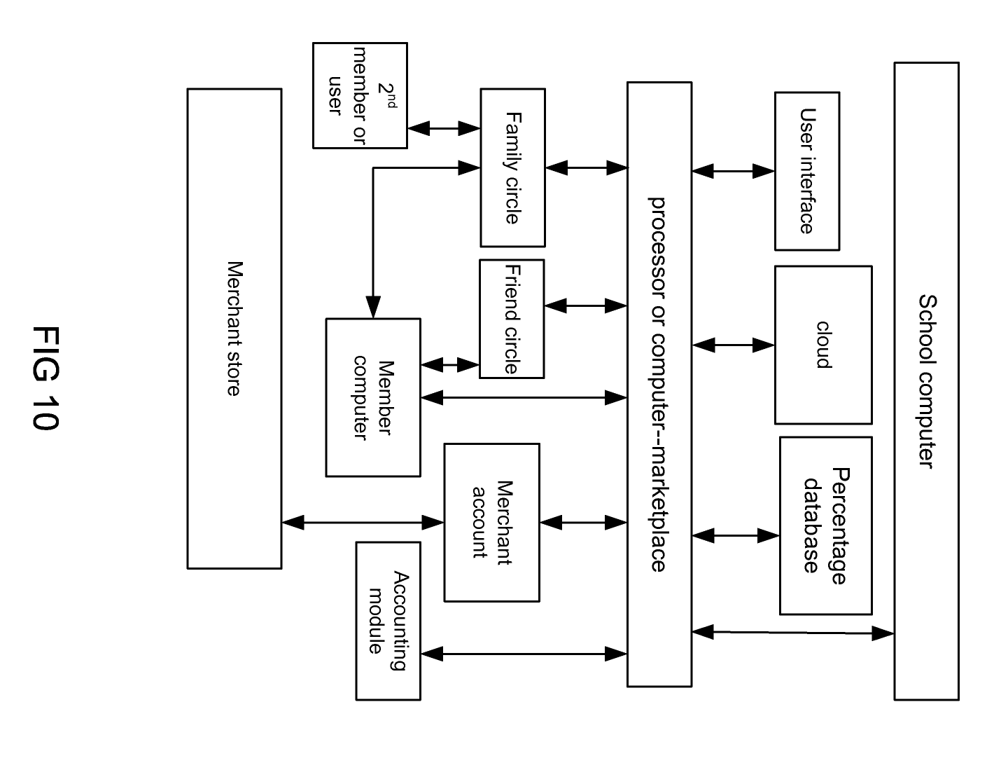

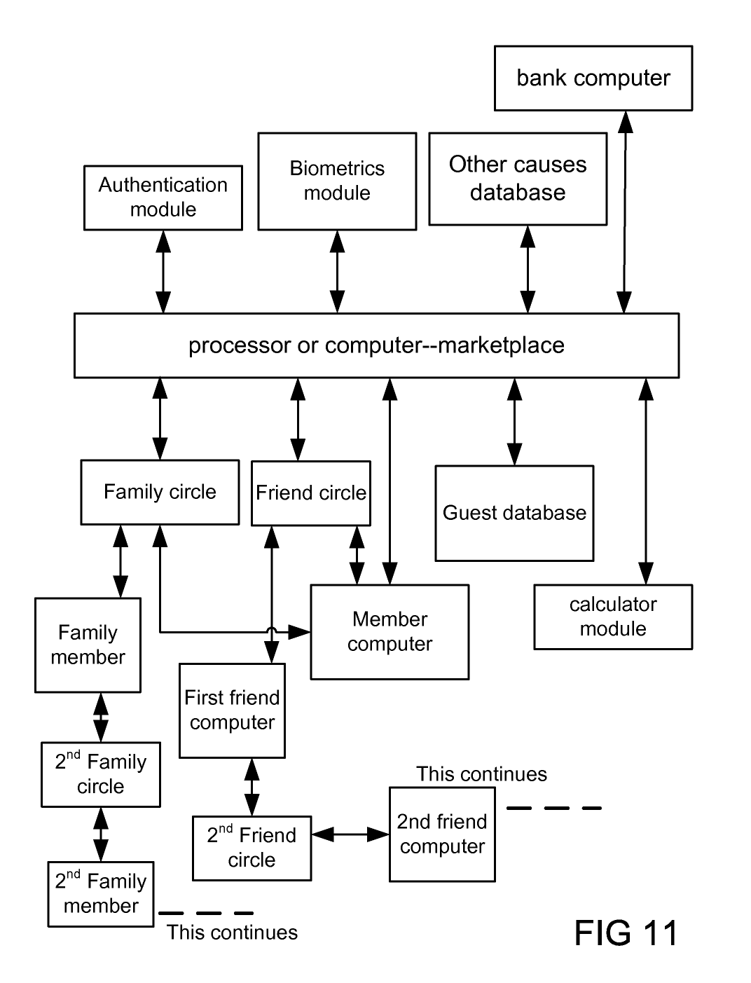

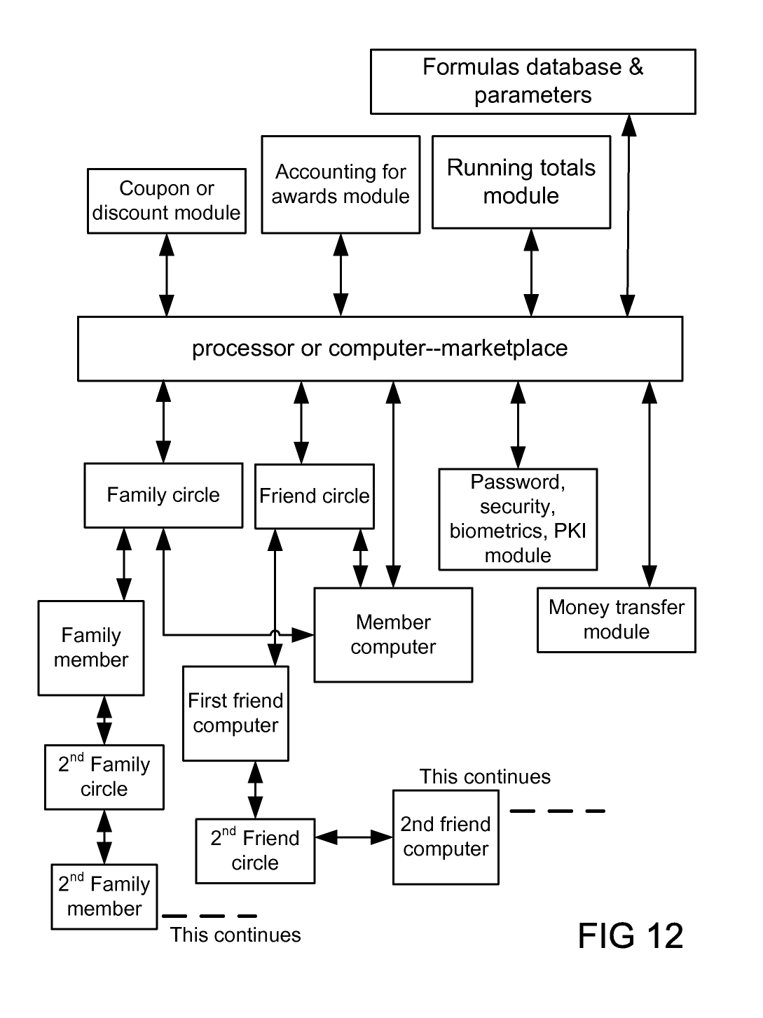

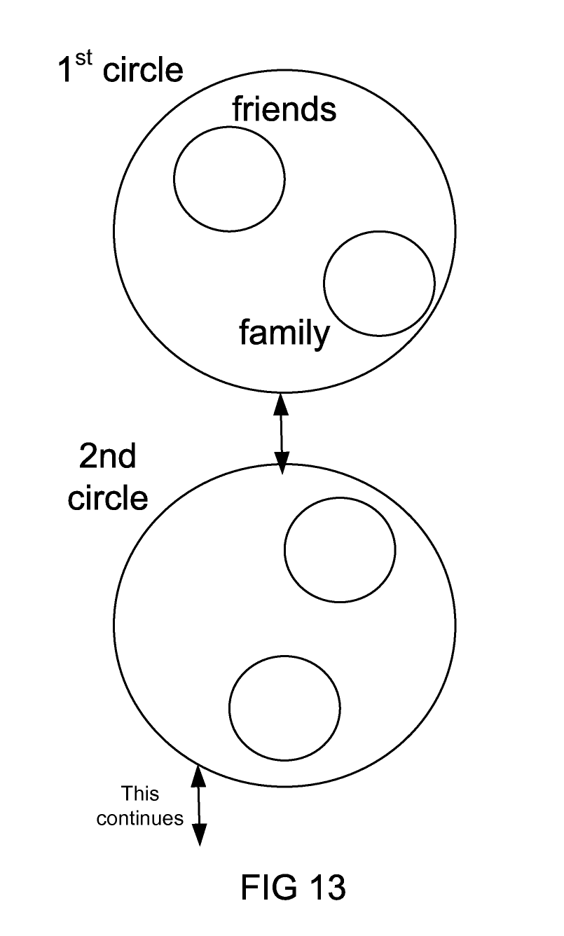

FIG. 10 is an embodiment of the invention for system for our marketplace. FIG. 11 is an embodiment of the invention for system for circle of friends and family. FIG. 12 is an embodiment of the invention for system for security and accounting. FIG. 13 is an embodiment of the invention for system for circles of friends and family, and their relationships, for multiple members and others.

In one embodiment, we have a method for interacting with a marketplace presented on a marketplace computer, for users of said marketplace, said method comprising: a member signing with said marketplace computer through a user interface device; said member inviting a first friend to a friends circle; wherein said friends circle is located on friends circle database; said friends circle database communicating with said marketplace computer; said member inviting a first family member to a family circle; wherein said family circle is located on family circle database; said family circle database communicating with said marketplace computer; a merchant or vendor signing up with said marketplace computer to offer a first service or object; said member buying said first service or object through said marketplace computer at a first value, V1; a school computer signing up with said marketplace computer; said school computer communicating with said marketplace computer; said marketplace computer assigning a first percentage, P1, to a school associated to said school computer; said first family member buying a second service or object at a second value, V2; said marketplace computer assigning a second percentage, P2, to said family circle; said first friend buying a third service or object at a third value, V3; said marketplace computer assigning a third percentage, P3, to said friends circle; said marketplace computer assigning a fourth percentage, P4, to a second cause; said first friend inviting a second friend into a second friends circle; said marketplace computer assigning a fifth percentage, P5, to said second friends circle; said second friend buying a fourth service or object at a fourth value, V4; said marketplace computer computing a first summation, S1, for contributions from said friends circle and said family circle; wherein:

S1=(V4·P5)P3+(V3·P3)+(V2·P2)

said marketplace computer computing a second summation, S2, for total contributions; wherein:

S2=V1+S1

said marketplace computer assigning a first contributed value, C1, to said school; wherein:

C1=P1·S2

said marketplace computer assigning a second contributed value, C2, to said second cause; wherein:

C2=P4·S2

an accounting module transferring said first contributed value to said school; said accounting module transferring said second contributed value to said second cause; said accounting module notifying said member about said transferred said first contributed value and said transferred said second contributed value; said accounting module adding said transferred said first contributed value and said transferred said second contributed value to a member total account; said accounting module notifying said first family member, said first friend, and said second friend on their respective contributions to said first summation; and said accounting module adding said their respective contributions to their respective totals for said first family member, said first friend, and said second friend.

Other embodiments are:
said second cause is said member's school tuition. said second cause is said member's children's school tuition. said second cause is said member's student loan. said second cause is said member's college tuition. said second cause is said member's house mortgage. said second cause is said member's school fundraising.
Percentage value, for any of the percentages, Pi, is 1 percent. Pi is in range of 0.01 to 10 percent.
said marketplace computer is in cloud. said marketplace computer is a server farm. said friends circle and said family circle are merged together.

In one embodiment, for a given person, the person may nominate a guest Q, which gets an encrypted session or password to get in, directly from member or from our web site, or a combination, e.g., with one key or password from us and one from member, which requires having both keys to get in the web site or do the transactions.

In one embodiment, for a given person, the person having authorizations, may get the following some or all of the authorizations: looking at the files, print the files, contribute money or do the purchases, change percentages, invite others, become a member, benefit from the deal, set his own percentage, limited access to data or deal or names or friends, or other friends, or other circles, or circles of circles, and the like. In one embodiment, for a given person, one uses public-private key configuration for authentication of the guests, or a password, or biometrics, or PIN, or card, or key, or hash function, or secured session.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A method for interacting with a marketplace presented on a marketplace computer, for users of said marketplace, said method comprising:
a member signing with said marketplace computer through a user interface device;
said member inviting a first friend to a friends circle;
wherein said friends circle is stored on friends circle database;
said friends circle database communicating with said marketplace computer;
said member inviting a first family member to a family circle;
wherein said family circle is stored on family circle database;
said family circle database communicating with said marketplace computer;
a merchant or vendor signing up with said marketplace computer to offer a first service or object;
said member buying said first service or object through said marketplace computer at a first value, V1;
a school computer signing up with said marketplace computer;
said school computer communicating with said marketplace computer;
said marketplace computer assigning a first percentage, P1, to a school associated to said school computer;
said first family member buying a second service or object at a second value, V2;
said marketplace computer assigning a second percentage, P2, to said family circle;
said first friend buying a third service or object at a third value, V3;
said marketplace computer assigning a third percentage, P3, to said friends circle;
said marketplace computer assigning a fourth percentage, P4, to a second cause;
said first friend inviting a second friend into a second friends circle;
said marketplace computer assigning a fifth percentage, P5, to said second friends circle;
said second friend buying a fourth service or object at a fourth value, V4;
said marketplace computer computing a first summation, S1, for contributions from said friends circle and said family circle;
wherein:
S1=(V4·P5)P3+(V3·P3)+(V2·P2)
said marketplace computer computing a second summation, S2, for total contributions;
wherein:
S2=V1+S1
said marketplace computer assigning a first contributed value, C1, to said school;
wherein:
C1=P1·S2
said marketplace computer assigning a second contributed value, C2, to said second cause;
wherein:
C2=P4·S2
an accounting module transferring said first contributed value to said school;
said accounting module transferring said second contributed value to said second cause;
said accounting module notifying said member about said transferred said first contributed value and said transferred said second contributed value;
said accounting module adding said transferred said first contributed value and said transferred said second contributed value to a member total account;
said accounting module notifying said first family member, said first friend, and said second friend on their respective contributions to said first summation; and
said accounting module adding said their respective contributions to their respective totals for said first family member, said first friend, and said second friend.

2. The method for interacting with a marketplace presented on a marketplace computer, as recited in claim 1, wherein said second cause is said member's school tuition.

3. The method for interacting with a marketplace presented on a marketplace computer, as recited in claim 1, wherein said second cause is said member's children's school tuition.

4. The method for interacting with a marketplace presented on a marketplace computer, as recited in claim 1, wherein said second cause is said member's student loan.

5. The method for interacting with a marketplace presented on a marketplace computer, as recited in claim 1, wherein said second cause is said member's college tuition.

6. The method for interacting with a marketplace presented on a marketplace computer, as recited in claim 1, wherein said second cause is said member's house mortgage.

7. The method for interacting with a marketplace presented on a marketplace computer, as recited in claim 1, wherein said second cause is said member's school fundraising.

8. The method for interacting with a marketplace presented on a marketplace computer, as recited in claim 1, wherein P1 is 1 percent.

9. The method for interacting with a marketplace presented on a marketplace computer, as recited in claim 1, wherein P1 is in range of 0.01 to 10 percent.

10. The method for interacting with a marketplace presented on a marketplace computer, as recited in claim 1, wherein P2 is 1 percent.

11. The method for interacting with a marketplace presented on a marketplace computer, as recited in claim 1, wherein P2 is in range of 0.01 to 10 percent.

12. The method for interacting with a marketplace presented on a marketplace computer, as recited in claim 1, wherein P3 is 1 percent.

13. The method for interacting with a marketplace presented on a marketplace computer, as recited in claim 1, wherein P3 is in range of 0.01 to 10 percent.

14. The method for interacting with a marketplace presented on a marketplace computer, as recited in claim 1, wherein P4 is 1 percent.

15. The method for interacting with a marketplace presented on a marketplace computer, as recited in claim 1, wherein P4 is in range of 0.01 to 10 percent.

16. The method for interacting with a marketplace presented on a marketplace computer, as recited in claim 1, wherein P5 is 1 percent.

17. The method for interacting with a marketplace presented on a marketplace computer, as recited in claim 1, wherein P5 is in range of 0.01 to 10 percent.

18. The method for interacting with a marketplace presented on a marketplace computer, as recited in claim 1, wherein said marketplace computer is in cloud.

19. The method for interacting with a marketplace presented on a marketplace computer, as recited in claim 1, wherein said marketplace computer is a server farm.

20. The method for interacting with a marketplace presented on a marketplace computer, as recited in claim 1, wherein said friends circle and said family circle are merged together.
